(19) United States
(12) Patent Application Publication
(10) Pub. No.: US 2008/0049466 A1
(43) Pub. Date: Feb. 28, 2008

(54) Method for Controlling Low-Voltage Using Waves Ac and System for Performing the Same

(76) Inventor: Young-Chang Cho, Cheongju-City (KR)

Correspondence Address: GREER, BURNS & CRAIN, 300 S WACKER DR, 25TH FLOOR, CHICAGO, IL, 60606, US

(21) Appl. No.: 11/596,696

(22) PCT Filed: May 23, 2005
(86) PCT No.: PCT/KR05/01488

§ 371 Date: Jul. 31, 2007

(30) Foreign Application Priority Data
May 24, 2004 (KR) 10-2004-0036974

(51) Int. Cl. H02H 7/125

(52) U.S. Cl. 363/53

(57) ABSTRACT

A method of controlling low voltage using a waveform of Alternating Current (AC) power, including; a full wave rectification step of fill-wave-rectifying input AC power; a switching step of performing a switching operation to generate four power outputs, whose voltage level is lower than that of set control voltage, in one cycle of the full-wave rectified AC power in such a way as to switch on low voltage portions of a waveform of the full-wave-rectified AC power whose voltage levels are lower than that of the set control power and switch off high voltage portions whose voltage levels are higher than that of the set control power; and an AC power output step of converting the low voltage portions, which are output at the switching step, into Direct Current (DC) voltage and outputting the DC voltage.

### TECHNICAL FIELD

The present invention relates generally to a method of controlling low voltage using alternating current power and a system for performing the method and, more particularly, to a method of controlling low voltage using the waveform of alternating current power and a system for performing the method, which allow low voltage direct current power to be supplied directly from commercial alternating current power, so that control can be stably performed when supplying power equal to 0%˜100% of the level of the alternating power, thereby achieving optimal efficiency and miniaturizing the system.

### BACKGROUND ART

Generally, power control using Alternating Current (AC) power employs a zero-crossing control method and a phase control method. In the zero-crossing control method, when voltage is zero, that is, when AC power advancing while forming a sine wave advances by one cycle and reaches point A having zero voltage, as illustrated in FIG. 1A, On/Off control is performed. In order to supply 50% of supplied AC power, power is controlled in such a way as to repeat a On/Off operation every cycle in the zero-crossing control method.

Such a zero-crossing method is superior from the point of view of power noise. However, the zero-crossing method requires a circuit for finding the zero point of AC power, that is, the point where voltage is zero after a cycle has completed, so that economical efficiency is low. Accordingly, the zero-crossing method can be utilized for expensive equipment, but has a disadvantage in that uniform power is not supplied in power control in which a control rate is low compared to the amount of AC power.

For example, in the case of controlling the power of a halogen lamp, which operates at 12V using 110V/220V commercial power, using the zero-crossing method, the halogen lamp is broken by power during an On-cycle, so that a transformer or a switching-type power supply has been used.

Furthermore, the phase control method controls power, which is supplied to a load, by varying the phase of supplied AC power as shown in FIG. 1B, so that the method is simple and, thus, may be used throughout the entire industry. However, the phase control method has disadvantages in that noise is high and the method is not stable for power control for less than 50% of supplied AC power because switching on and off are performed at high voltage positions, and uniform power is not supplied.

That is, the conventional zero-crossing method and phase control method perform the On/Off control of power based on phase according to time, whereas a novel method proposed by the present invention can perform the On/Off control of power based on voltage.

### DISCLOSURE OF INVENTION

Technical Problem

The present invention has been contrived so as to overcome the disadvantages of the zero-crossing method and the phase control method, and converts supplied AC power into low Direct Current (DC) power by uniformly and stably controlling the supplied AC power without conversion loss using only On/Off switching between an input terminal and a load. Accordingly, a first object of the present invention is to provide a low voltage control method that can supply highly efficiency DC power from commercial AC power using semiconductors and resistors, so that optimal operational efficiency and economic efficiency are achieved and a power control device can be implemented using a single Integrated Circuit (IC).

Furthermore, a second object of the present invention is to provide a system for achieving the first object.

Technical Solution

To achieve the first object, the present invention includes:

a full wave rectification step of full-wave-rectifying input AC power;

a switching step of performing a switching operation to generate four power outputs, whose voltage level is lower than that of set control voltage, in one cycle of full-wave rectified AC power in such a way as to switch on low voltage portions of a waveform of the full-wave-rectified AC power whose voltage levels are lower than that of the set control power and switch off high voltage portions whose voltage levels are higher than that of the set control power; and

an AC power output step of converting the low voltage portions, which are output at the switching step, into DC voltage and outputting the DC voltage.

In accordance with a preferred embodiment of the present invention, the present invention further includes an excessive current detection step of blocking the operation of the switching step if excessive current is applied at the switching step or if the output voltage at the switching step is abnormal voltage.

In the low voltage control of the present invention, a switching operation is performed to generate two outputs, whose voltage levels are lower than that of that of the control voltage, in the positive (+) direction of the input AC power and two outputs, whose voltage levels are lower than that of that of the control voltage, in the negative (−) direction of the input AC power.

When converting commercial AC power into DC power, the low voltage control method of the present invention performs DC power conversion using only On/Off operations between the input terminal of the AC power and a load. Accordingly, conversion loss is low, and power consumption is also low as long as the load does not operate. That is, the present invention employs a method of performing On/Off operations on the basis of the size of an AC waveform input between an AC power source and the load, so that efficiency is high, and noise is low because switching operations are not frequency performed.

To achieve the second object, the present invention includes:

a rectification unit for receiving and full-wave-rectifying commercial AC power;

a voltage level detection unit connected to an output terminal of the rectification unit and configured to detect set control voltage required by a load;

a power switching unit connected to an output terminal of the voltage level detection unit and configured to perform a switching operation according to the set control voltage and operate to generate four outputs, which have levels lower than that of the set control voltage, in one cycle of the full-wave-rectified AC power; and

a DC conversion unit for converting the outputs of the power switching unit into DC voltage.

In accordance with a preferred embodiment of the present invention, the present invention further includes an excessive current detection unit that is connected to the output terminal of the power switching unit and is configured to detect excessive current from the output current of the power switching unit and cut off power applied to the power switching unit, and an abnormal voltage detection unit that is connected to the output terminal of the power switching unit and is configured to block the operation of the power switching unit when abnormal voltage, such as excessive voltage, is applied.

### BRIEF DESCRIPTION OF THE DRAWINGS

FIGS. 1A and 1B are waveform diagrams illustrating a zero-crossing method and a phase control method that are used for general power control;

FIG. 2 is a waveform diagram illustrating the operation of a low voltage control method according to the present invention;

FIG. 3 is a block diagram of a system for implementing the low voltage control method according to the present invention;

FIG. 4 shows a first embodiment of a circuit that implements the low voltage control system according to the present invention;

FIG. 5 shows a second embodiment of a circuit that implements the low voltage control system according to the present invention; and

FIG. 6 is a waveform diagram illustrating the output waveforms of power that has passed the systems of FIGS. 4 and 5.

### BEST MODE FOR CARRYING OUT THE INVENTION

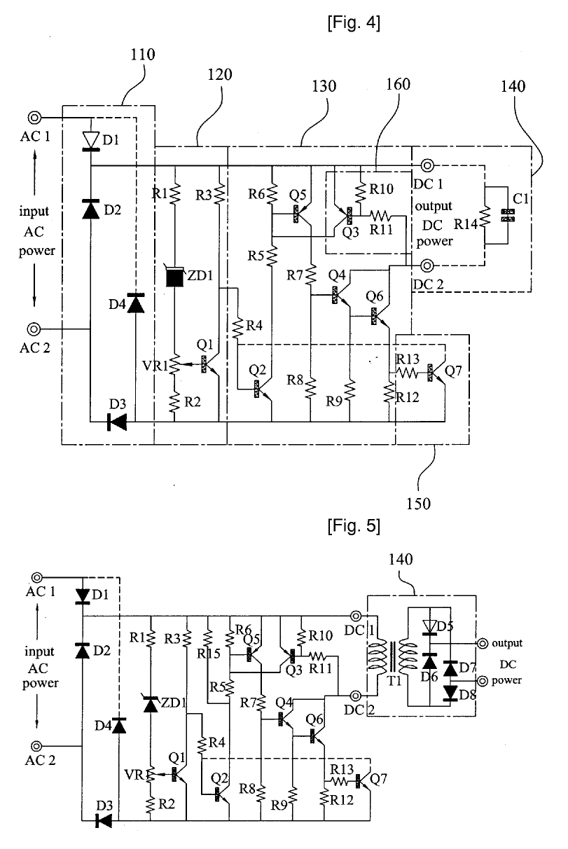

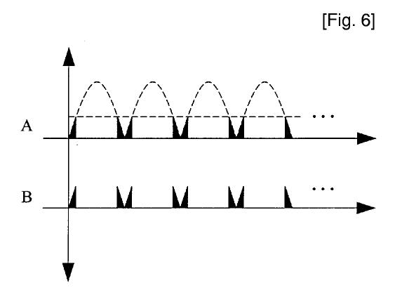

With reference to the accompanying drawings, preferred embodiments of the present invention are described in detail below. FIG. 2 is a waveform diagram illustrating the operation of a low voltage control method according to the present invention, and FIG. 3 is a block diagram of a system for implementing the low voltage control method according to the present invention. Furthermore, FIG. 4 shows a first embodiment of a circuit that implements the low voltage control system according to the present invention, FIG. 5 shows a second embodiment of a circuit that implements the low voltage control system according to the present invention, and FIG. 6 is a waveform diagram illustrating the output waveforms of power that has passed the systems of FIGS. 4 and 5.

The low voltage control method according to the present invention, as shown in FIG. 2, full-wave-rectifies input AC power, and then performs control to switch on the low voltage portions of a full-wave-rectified sine waveform whose voltage is lower than control voltage set according to the amount of target power, and switch off the high voltage portions thereof whose voltage is higher than the set control voltage. Accordingly, control is performed such that the On/Off operations of AC power can be performed on low voltage portions, so that the present invention has low switching noise compared to the phase control method in which On/Off operation is performed on high voltage portions.

The system for performing the low voltage control method of the present invention, as shown in FIG. 3, includes a rectification unit 110 composed of a bridge circuit for receiving commercial AC power and full-wave-rectifying the AC power. A voltage level detection unit 120 for detecting set control voltage required by a load is connected to the output terminal of the rectification unit 110. Furthermore, a power switching unit 130 for performing switching according to the set control voltage and operating to generate four outputs, whose voltage level is lower than that of the set control voltage, in a cycle of the full-wave-rectified AC power is connected to the output terminal of the voltage level detection unit 120, and a DC conversion unit 140 for converting power, which is output from the power switching unit 130, into DC power is connected to the output terminal of the power switching unit 130.

Furthermore, an excessive current detection unit 150 for detecting excessive current from the output current of the power switching unit 130 and cutting off the supply of power to the power switching unit 130 is connected to the output terminal of the power switching unit 130, and an abnormal voltage detection unit 160 for blocking the switching operation of the power switching unit 130 when abnormal voltage, such as excessive voltage, is applied is connected to the output terminal of the power switching unit 130.

The system for performing the low voltage control method of the present invention is connected between the input terminal of commercial AC power and a load, and functions to detect the voltage level of the sine waveform of the input commercial AC power and switch on/off the input commercial AC power such that only portions that have voltage levels lower than that of the set control voltage required by the load can pass through the system. That is, if it is assumed that power required by the load is 10% of commercial AC power (that is, if the input commercial AC power is 100V, the power required by the load is 10V), the system of the present invention converts 10% of commercial AC power into DC power and supplies the DC power using a method of repeating switching-on/off operations in such a way as to switch on voltage whose level is below 20%, and switch off voltage whose voltage level is above 20%, unlike the conventional power control method that perform control in such a way as to transmit 100% power and keep interruption time 10 times, so that the degree of smoothness of power that is output to a load is considerably reduced. Accordingly, the present invention is a low voltage control method that considerably improve the degree of smoothness.

The system for performing the low voltage control of the present invention may be implemented in a circuit form, as shown in FIGS. 4 and 5. In embodiment 1 of FIG. 4, the rectification unit 110 is constructed such that bridge circuits D1˜D4 for full-wave-rectifying the commercial AC power are connected to terminals AC1 and AC2 to which the commercial AC power is applied, and the voltage level detection unit 120 is connected to the side output terminals of the bridge circuits D1˜D4. Resistors R1 and R2 are connected in series between the side output terminals through which the AC power, which is full-wave rectified by the bridge circuits D1˜D4, is output, a zener diode ZD1 for keeping voltage uniform and a variable resistor VR1 having a variable resistance value are connected in series between the resistors R1 and R2, the base terminal of a first transistor Q1 for transferring a switching signal according to the set value of the variable resistor VR1 is connected to the variable resistor VR1, the emitter terminal of the first transistor Q1 is directly connected to the output terminals of the system, and the collector terminal of the first transistor Q1 is connected to another output terminal of the system through a resistor R3, thus constructing the voltage level detection unit 120.

Furthermore, the power switching unit 130 is constructed such that the base terminal of the second transistor Q2 is connected via a resistor R4 between the collector terminal of the first transistor Q1 and the resistor R3 that constitute the voltage level detection unit 120, the emitter terminal of the second transistor Q2 is directly connected to an output terminal of the system, the collector terminal of the second transistor Q2 is connected to another output terminal of the system via resistors R5 and R6, the base terminal of a PNP-type fifth transistor Q5 is connected between the resistors R5 and R6 that are connected in series to the collector terminal of the second transistor Q2, the emitter terminal of the fifth transistor Q5 is directly connected to an output terminal of the system, and the collector terminal of the fifth transistor Q5 is connected to another output terminal of the system through resistors R7 and R8 that are connected in series to each other. Furthermore, the base terminal of the fourth transistor Q4 is connected between resistors R7 and R8 that are connected in series to the collector terminal of the fifth transistor Q5, the emitter terminal of the fourth transistor Q4 is connected to an output terminal of the system through a resistor R9, the collector terminal of the fourth transistor Q4 is directly connected to another output terminal of the system, the base terminal of the sixth transistor Q6 is connected between the collector terminal of the fourth transistor Q4 and the resistor R9, the emitter terminal of the sixth transistor Q6 is connected to an output terminal of the system through a resistor R12, and the collector terminal of the sixth transistor Q6 is directly connected to another output terminal of the system.

Furthermore, the AC power unit 140 is composed of a resistor R14 and a condenser C1 that are connected in parallel to the output terminals of the power switching unit 130, and converts the output of the power switching unit 130 into DC power by smoothing the output of the power switching unit 130.

Furthermore, the excessive current detection unit 150 is constructed such that a branch extends from a point between the emitter terminal of the sixth transistor Q6 of the power switching unit 130 and the resistor R12 and is connected to the base terminal of a seventh transistor Q7 through a resistor R13, the collector terminal of the seventh transistor Q7 is connected to the base terminal of the second transistor Q2 of the power switching unit 130, and the emitter terminal of the seventh transistor Q7 is connected to the output terminal of the system.

Furthermore, the abnormal voltage detection unit 160 is constructed such that a branch extends from a point between the resistors R10 and R11 that are connected in series between output terminals DC1 and DC2 for outputting DC power, and is connected to the base terminal of the PNP-type third transistor Q3, the collector terminal of the third transistor Q3 is connected to the base terminal of the fifth transistor Q5 of the power switching unit 130, and the emitter terminal of the third transistor Q3 is connected to the output terminals of the system.

In embodiment 1 of the system for controlling low voltage control in accordance with the present invention, which is constructed as described above, when commercial AC power is applied through the terminals AC1 and AC2, input AC power is full-wave-rectified by the bridge rectifiers D1˜D4 that constitute part of the rectification unit 110. The full-wave-rectified AC power switches on/off the first transistor Q1 according to a control voltage value that is set by the resistors R1 and R2 of the voltage level detection unit 120, the zener diode ZD1 for keeping voltage uniform and the variable resistor VR1 whose resistance value varies. That is, when the level of the power full-wave-rectified by the rectification unit 110 is higher than a voltage level set by the resistors R1 and R2 and the variable resistor VR1, the first transistor Q1 is switched on. As the first transistor Q1 is switched on, the second transistor Q2 of the power switching unit 130 is converted into a switched-off state. When the second transistor Q2 is switched off, the operations of the PNP-type fifth transistor Q5, fourth transistor Q4 and sixth transistor Q6 sequentially stop. As a result, the power switching unit 130 does not output full-wave-rectified power whose voltage level is higher than the level of the control voltage that is set by the resistors R1 and R2 and variable resistor VR1 of the voltage level detection unit 120.

In contrast, if the level of the power full-wave-rectified by the rectification unit 110 is lower than the level of the control voltage set by the resistors R1 and R2 and the variable resistor VR1, the first transistor Q1 is switched off. Accordingly, the second transistor Q2 of the power switching unit 130 is switched off. As the second transistor Q2 is switched off, the PNP-type fifth transistor Q5 is caused to be switched on through the resistor R5. As the fifth transistor Q5 is switched on, the current having passed through the fifth transistor Q5 is applied to the fourth transistor Q4 through the resistor R7, is amplified and switches on the sixth transistor Q6. Accordingly, the full-wave-rectified power is applied to the DC conversion unit 140, is smoothed by the resistor R14 and the condenser C1 connected in parallel, and is output in DC power form. As a result, only power whose voltage level is lower than the level of the control voltage set by the resistors R1 and R2 and variable resistor VR1 of the voltage level detection unit 120 is converted into DC power and is output.

As described above, in the process in which only power whose voltage level is lower than the level of the control voltage set by the resistors R1 and R2 and variable resistor VR1 of the voltage level detection unit 120 is converted into DC power and is output, if output current is excessive at the DC output terminal DC2, that is, if current applied to the resistor R12 through the emitter terminal of the sixth transistor Q6 of the power switching unit 130 is excessive, the seventh transistor Q7 of the excessive current detection unit 150 operates, cuts off the base terminal of the second transistor Q2 of the current power switching unit 130, and stops the operation of the power switching unit 130, so that the circuit can be protected even if the output terminal is short-circuited.

Furthermore, if abnormal voltage is generated while DC power is output, the abnormal voltage operates the PNP-type third transistor Q3 through the resistor R11 of the abnormal voltage detection unit 160, and the third transistor Q3 stops the operation of the power switching unit 130 by cutting off current applied to the base terminal of the fifth transistor Q5 of the power switching unit 130, thus preventing abnormal voltage, such as excessive voltage, from being output.

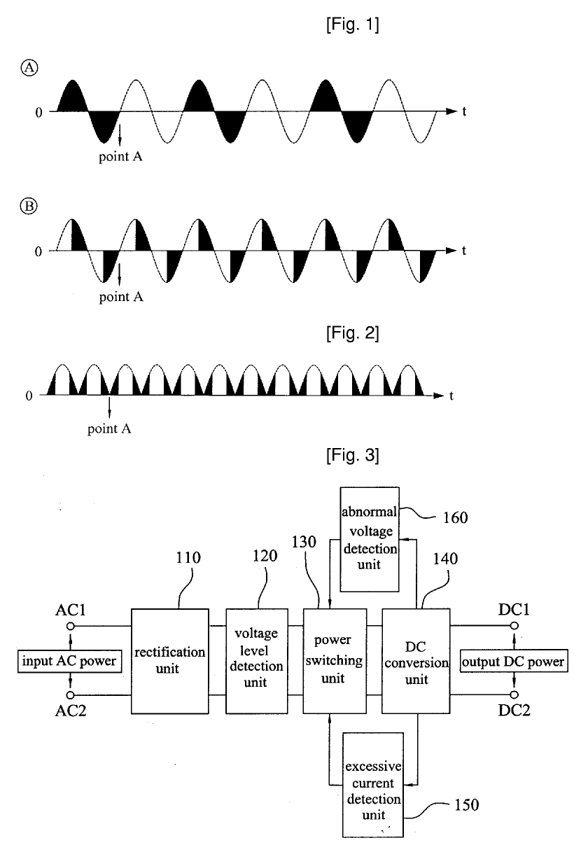

When the above-described low voltage control is completed, four outputs, which have voltage levels lower than the set level of control voltage, appear in a cycle of the full-wave-rectified AC power, as illustrated in FIGS. 6A and 6B. The above-described low voltage control method according to the present invention has great advantages over the conventional methods when the voltage drop between input power and output power is large. For example, if it is assumed that power supplied to a load is about 10% of AC power (when the voltage of input power is 100V, the voltage of output power is 10V), the zero-crossing control method of FIG. 1A is disadvantageous in that high switching noise occurs, smoothing is difficult to achieve and a load may be damaged because only a cycle of the AC power is transmitted and the remaining nine cycles are not transmitted (the ratio of switched-on time to switched-off time is 1:10), whereas the method of the present invention is advantageous in that the difference between the levels of switched-on voltage and switched-on voltage is not larger and, thus, the level of output voltage is even and even power is supplied to a load because the voltage levels of switched-on and switched-off states are 15˜20 (which varies with voltage) and 0.

The above-described advantages of the present invention are desirable in the case where it is necessary to acquire low DC power directly from commercial AC power voltage. The present invention facilitate the supply of power to low voltage DC power devices using commercial power, so that it can be widely utilized.

Furthermore, as shown in FIG. 5, another embodiment of the present invention has the same principle as the embodiment of FIG. 4. However, the AC conversion unit 140 is constructed in such a way that the primary side of a transformer T1 is connected to the output terminal of the power switching unit 130 and bridge rectifiers D5˜D8 are connected to the secondary side of the transformer T1, and is operated in such a way that only voltage lower than a predetermined voltage level is transmitted and supplied by a voltage level detection and switching operation, the voltage is varied by the transformer T1 and the voltage is converted into DC voltage through the bridge rectifiers D5˜D8.

FIG. 5 shows a structure that employs an insulation transformer T1 to realize insulation between commercial power and a load in connection with the supply of DC power. The frequency of power applied to the transformer T1 is above 120 Hz or 240 Hz, not 60 Hz, due to a switching operation, so that the size of a transformer capable of transferring the same power decreases and the efficiency of the transformer increases.

The above-described advantages of the present invention are prominent when compared with the conventional power control, as shown in FIGS. 1 and 2. The zero-crossing control shown in FIG. 1 causes the lowest switching noise because On/Off operations are performed when voltage level of input AC voltage is zero, and has the widest range of variation in voltage because, to output 50% of the voltage level of AC power, one cycle is transmitted and the remaining one cycle is not transmitted,

Furthermore, the phase control has the highest switching noise because a switching-on operation is performed when the voltage level is at a peak, but has the advantage of outputting a voltage level four times evenly than the zero-crossing control because, to output 50% of the voltage level of input AC power, half of the positive (+) direction wave of one cycle and half of the negative (−) direction wave are evenly transmitted.

In the present invention, as shown in FIG. 2, to output 50% of the voltage level of input AC power, two positive (+) direction waves of one cycle and two (−) direction waves are evenly transmitted, so that switching noise may be high. The present invention is advantageous in that the voltage level two times even than the phase control is transmitted, and the present invention can be composed of a simple circuit as described above, thus being economically efficient. The present invention is more advantageous when an output voltage level is low.

The present invention has advantages that increase in inverse proportion to a voltage level as described above. Accordingly, in the case where the present invention is used as a low voltage DC power supply that rectifies output controlled to low voltage, the present invention is the most efficient of the conventional methods of converting AC voltage down to DC voltage (about 80%˜95%) and, accordingly, has a strong possibility of being used as a super-small power supply. Standby power consumption without load is less than 0.1 W in the case of a BJT circuit, and 0.01 W in the case of a C-MOS FET. That is, when the low voltage control systems of FIGS. 4 and 5 are implemented using ICs, output of 3V˜12V and several tens of watts can be achieved using a 10 mm cubic body.

### INDUSTRIAL APPLICABILITY

As described above, the present invention employs the switching method that performs voltage level control on the voltage waveform of AC voltage, so that the present invention can efficiently and stably perform low voltage control, can overcome the disadvantages of phase control, which is unstable when control is performed for 50% or less of the voltage level of AC power, and zero-crossing control, in which uniform control is not formed, and can implement a power supply for producing low DC voltage directly from commercial AC voltage in a super-small size. The present invention can be implemented using a circuit composed of only resistors and transistors, so that the present invention can be implemented using a small IC, thus allowing a highly efficient and safe circuit to be designed because the circuit has high efficiency and, therefore, enabling a power control device having economical efficiency to be implemented.

Although the preferred embodiments of the present invention have been described in detail with reference to the accompanying drawings as described above, the present invention is not limited to the embodiments, but modifications and variations can be made by those skilled in the art without departing from the scope of the technical spirit of the present invention.

1. A method of controlling low voltage using a waveform of Alternating Current (AC) power, comprising;
a full wave rectification step of full-wave-rectifying input AC power;
a switching step of performing a switching operation to generate four power outputs, whose voltage level is lower than that of set control voltage, in one cycle of the full-wave rectified AC power in such a way as to switch on low voltage portions of a waveform of the full-wave-rectified AC power whose voltage levels are lower than that of the set control power and switch off high voltage portions whose voltage levels are higher than that of the set control power; and
an AC power output step of converting the low voltage portions, which are output at the switching step, into Direct Current (DC) voltage and outputting the DC voltage.

2. The method set forth in claim 1, further comprising an excessive current detection step of blocking operation of the switching step if the output power is excessive current after the switching step.

3. The method set forth in claim 1, further comprising an excessive current detection step of blocking operation of the switching step if the output power at the switching step is abnormal voltage.

4. A system for controlling low voltage, comprising:
a rectification unit for receiving and full-wave-rectifying commercial AC power;
a voltage level detection unit connected to an output terminal of the rectification unit and configured to detect set control voltage required by a load;
a power switching unit connected to an output terminal of the voltage level detection unit and configured to perform a switching operation according to the set control voltage and operate to generate four outputs, which have levels lower than that of the set control voltage, in one cycle of the full-wave-rectified AC power; and
a DC conversion unit for converting the outputs of the power switching unit into DC voltage.

5. The system as set forth in claim 4, wherein the voltage level detection unit is constructed such that resistors are connected in series between side output terminals through which the AC power, which is full-wave rectified by the rectification unit, is output, a zener diode for keeping voltage uniform and a variable resistor having a variable resistance value are connected in series between the resistors, a base terminal of a first transistor for transferring a switching signal according to a set value of the variable resistors is connected to the variable resistor, an emitter terminal of the first transistor is directly connected to output terminals of the system, and a collector terminal of the first transistor is connected to another output terminal of the system through a resistors.

6. The system as set forth in claim 4, wherein the power switching unit is constructed such that a base terminal of a second transistor is connected via a resistor between the collector terminal of the first transistor and the resistor that constitute the voltage level detection unit an emitter terminal of the second transistor is directly connected to an output terminal of the system, a collector terminal of the second transistor is connected to another output terminal of the system via resistors, a base terminal of a PNP-type fifth transistor is connected between resistors that are connected in series to the collector terminal of the second transistor, an emitter terminal of the fifth transistor is directly connected to an output terminal of the system, a collector terminal of the fifth transistor is connected to another output terminal of the system through resistors that are connected in series to each other, a base terminal of a fourth transistor is connected between the resistors that are connected in series to the collector terminal of the fifth transistor, an emitter terminal of the fourth transistor is connected to an output terminal of the system through a resistor, a collector terminal of the fourth transistor is directly connected to another output terminal of the system, a base terminal of the sixth transistor is connected between the collector terminal of the fourth transistor and the resistors, an emitter terminal of the sixth transistor is connected to an output terminal of the system through a resistor, and a collector terminal of the sixth transistor is directly connected to another output terminal of the system.

7. The system as set forth in claim 4 wherein the AC power unit is composed of a resistor and a condenser that are connected in parallel to the output terminal of the power switching unit.

8. The system as set forth in claim 4, further comprising an excessive current detection unit for detecting excessive current from output current of the power switching unit and cutting off power applied to the power switching unit the excessive current detection unit being connected to the output terminal of the power switching unit.

9. The system as set forth in claim 4, wherein the excessive current detection unit is constructed such that a branch extends from a point between the emitter terminal of the sixth transistor and resistor of the power switching unit and is connected to a base terminal of a seventh transistor through a resistor, a collector terminal of the seventh transistor is connected to the base terminal of the second transistor of the power switching unit, and an emitter terminal of the seventh transistor is connected to the output terminal of the system.

10. The system as set forth in claim 4, further comprising an abnormal voltage detection unit for blocking operation of the power switching unit when abnormal voltage is detected from output of the power switching unit, the abnormal voltage detection unit being connected to the output terminal of the power switching unit.

11. The system as set forth in claim 4, wherein the abnormal voltage detection unit is constructed such that a branch extends from a point between the resistors that are connected in series between output terminals for outputting DC power, and is connected to the base terminal of a PNP-type third transistor, the collector terminal of the third transistor is connected to the base terminal of the fifth transistor of the power switching unit and the emitter terminal of the third transistor is connected to the output terminal of the system.

12. The system as set forth in claim 4, wherein the DC conversion unit is constructed such that a primary side of a transformer is connected to the output terminal of the power switching unit and bridge rectifiers are connected to a secondary side of the transformer.

13. The system as set forth in claim 8, wherein the excessive current detection unit is constructed such that a branch extends from a point between the emitter terminal of the sixth transistor and resistor of the power switching unit and is connected to a base terminal of a seventh transistor through a resistor, a collector terminal of the seventh transistor is connected to the base terminal of the second transistor of the power switching unit, and an emitter terminal of the seventh transistor is connected to the output terminal of the system.

14. The system as set forth in claim 10, wherein the abnormal voltage detection unit is constructed such that a branch extends from a point between the resistors that are connected in series between output terminals for outputting DC power, and is connected to the base terminal of a PNP-type third transistor, the collector terminal of the third transistor is connected to the base terminal of the fifth transistor of the power switching unit and the emitter terminal of the third transistor is connected to the output terminal of the system.
